(19) United States
(12) Patent Application Publication
(10) Pub. No.: US 2022/0399693 A1
(43) Pub. Date: Dec. 15, 2022

(54) METHOD AND DEVICE FOR PROCESSING AN ELECTRICAL CABLE

(71) Applicant: Metzner Holding GmbH, Ulm (DE)

(72) Inventor: Manfred SORG, Ulm (DE)

(21) Appl. No.: 17/775,616

(22) PCT Filed: Nov. 19, 2020
(86) PCT No.: PCT/EP2020/082657

§ 371 Date: May 10, 2022

(30) Foreign Application Priority Data
Nov. 25, 2019 (DE) 10 2019 131 759.2

(51) Int. Cl. H01R 43/28; H02G 1/12; H01R 13/6592

(52) U.S. Cl. CPC H01R 43/28; H02G 1/1297; H01R 13/6592; H02G 1/1285

(57) ABSTRACT

The invention relates to a method for processing an electrical cable (2), according to which a braided cable shield (6) of the cable (2), which is exposed along a longitudinal axis (L) of the cable (2) from a cable end (5) which is to be processed to a first stripping position (P_{A1}), is, by means of brushing with at least one drivable brush (10), folded back towards a cable end facing away from the cable end (5) to be processed. According to the invention, a defined fold-back position (P_{U}) for the braided cable shield (6) is determined along the longitudinal axis (L) of the cable (2). Before and/or during brushing, a front end of the forming sleeve (12), said front end facing the cable end (5) to be processed, is placed onto the cable (2) and positioned at the fold-back position (P_{U}) in order to fold back the braided cable shield (6) onto the forming sleeve (12) starting from the fold-back position (P_{U}). According to the invention, the fold-back position (P_{U}) is determined in such a way that the fold-back position (P_{U}) deviates from the first stripping position (P_{A1}) and/or that the forming sleeve (12) has an end-face stop surface (20) for the braided cable shield (6).

The invention relates to a method for processing an electrical cable, according to which method a braided cable shield of the cable that, proceeding from a cable end to be processed, is exposed along a longitudinal axis of the cable up to a first stripping position, is folded back toward a cable end facing away from the cable end to be processed, according to the preamble of claim 1.

The invention furthermore relates to a device for processing an electrical cable, according to the preamble of claim 21.

The invention also relates to a computer program product having program code means for carrying out a method for processing an electrical cable. Moreover, the invention relates to a mold shell for a device for processing an electrical cable, and to an electrical cable.

The processing of an electrical cable typically takes place in the context of fabricating the electrical cable, in order to connect the electrical conductors of the cable to an electrical plug connector. In the context of fabricating the cable, at least one end of the electrical cable is thus processed in order for the latter to be prepared for the connection to a plug connector, or for a plug connector to be partially or completely fitted to the cable end to be processed.

The processing of the cable end, or of the cable ends to be processed of the electrical cable here can comprise, inter alia, the stripping or exposing, respectively, of outer conductors and inner conductors, the cutting-to-length of the cable in regions, the application of a support sleeve of the later plug connector to the cable sheath of the cable, the folding back or folding over of an outer connector or of a braided cable shield of the cable onto the support sleeve, the application of a press-fit or crimped sleeve to the braided cable shield folded over of the support sleeve, and/or the final assembly of the plug connector.

The folding of the outer conductor typically presents particular difficulties here, in particular when the outer conductor is configured as a braided cable shield. While this processing step can be carried out manually in a comparatively simple manner, with a view to reducing costs in volume manufacturing it is nevertheless advantageous to pursue machine, or ideally fully automated, assembling.

A corresponding method which can be automated by machines is known from EP 1 886 387 B1, for example. A method in which a braided cable shield is impinged with a radial force across at least part of the circumference of the former is described in EP 1 886 387 B1, a plier-like tool being used to this end. As a result, the braided cable shield can be radially enlarged and finally folded over. However, it has been demonstrated that the method is not equally suitable for all types of plug connectors and does not always lead to satisfactory results in particular in the case of multi-core cables having a non-symmetrical cross section of the braided cable shield.

A method for manually folding a braided cable shield which may also be suitable for non-symmetrical cable structures is proposed in JP 2010 11 599 A, for example. It is proposed to first straighten the braided cable shield by brushing, using two rotating brushes, and for said braided cable shield to be subsequently folded backward over the cable sheath by changing the rotating direction of the brushes.

A similar principle is also disclosed in EP 2 117 089 A1. It is proposed in EP 2 117 089 A1 to fold the braided cable shield onto the cable sheath by means of a rotating brush in the context of mechanized processing. In order to also be able to insert a support sleeve or other plug connector component of the later plug connector between the cable sheath and the braided cable shield after the braided cable shield has been folded, the braided cable shield is optionally folded not directly onto the cable sheath but onto a conical or tapered spacer sleeve.

It has been demonstrated in practice that the known methods, in particular also the method of EP 2 117 089 A1, do not provide sufficient flexibility in order to process different cables and plug connector types.

In view of the known prior art, the object of the present invention thus lies in providing a method for processing an electrical cable which offers in particular a high degree of flexibility when folding a braided cable shield.

The present invention is also based on the object of providing a device for processing an electrical cable, which offers in particular a high degree of flexibility when folding a braided cable shield.

Finally, it is also an object of the invention to provide an advantageous computer program product and a mold shell for a device for processing an electrical cable.

It is moreover an object of the invention to provide an electrical cable which is preferably particular advantageously preprocessed for subsequent fabrication.

This object is achieved for the method with the features set forth in claim 1. In terms of the device, the object is achieved by the features of claim 21. In terms of the computer program product, the object is achieved by the features of claim 22, and in terms of the mold shell the object is achieved by claim 23. With a view to the electrical cable, the object is achieved by claim 24.

The dependent claims and the features described hereunder relate to advantageous embodiments and variants of the invention.

Provided is a method for processing an electrical cable, in particular for the fabrication of the electrical cable having an electric plug connector, according to which method a braided cable shield of the cable that, proceeding from a cable end to be processed, is exposed along a longitudinal axis of the cable up to a first stripping position, by brushing by means of at least one drivable brush is folded back in the direction of a cable end which faces away from the cable end to be processed.

For the purpose of simplification, the cable end to be processed is also referred to hereunder as the “front cable end”, or is associated with the relative directional indication “front”, whereas the cable end which faces away from the cable end to be processed hereunder is at times also referred to as the “rear cable end”, or is associated with the relative directional indication “rear”.

In the context of the processing according to the invention, the braided cable shield is preferably actually folded backward and not only upright. The braided cable shield is particularly preferably completely folded over.

In principle, the invention is suitable for use with any arbitrary electrical cable which comprises at least one electrical conductor. Apart from an outer conductor, the electrical cable preferably comprises at least one inner conductor, optionally also two, three, four, five, six or even more, inner conductors. The invention is particularly suitable for use with an electrical cable of which the outer conductor is configured as a braided cable shield, i.e. as braided individual strands or individual wires, respectively.

For example, the invention can be very suitable for processing a cable end of a coaxial cable or of a multi-core data cable (data cable having a plurality of inner conductors), in particular for the high frequency sector.

Brushing of the braided cable shield for folding the braided cable shield can be particularly advantageously suitable for different cable types or cable geometries, respectively, and thus also lead to a positive result independently of the specific type of cable. “Brushing back” the cable can in particular be very suitable even in the case of oval braided cable shields, for example for data lines having several inner conductors in which the inner conductors cannot be symmetrically distributed in the cable (for example in the case of a data cable having exactly two inner conductors).

The at least one brush for folding (toward the “rear”) the braided cable shield in the direction of the cable end of the cable which faces away from the cable end to be processed can be driven or rotated, respectively.

It is provided according to the invention that a defined folding position for the braided cable shield is determined along the longitudinal axis of the cable.

The folding position is the position along the longitudinal axis of the cable, proceeding from which the braided cable shield is folded, or kinked for folding, respectively. The folding position can in particular be the reversal point of the profile of the folded braided cable shield where the braided cable shield reverses the profile thereof in the direction toward the rear cable end.

According to the invention, it is moreover provided that a mold shell is applied to the cable before and/or during brushing and by way of a front end which faces the cable end to be processed is positioned at the folding position so as to, proceeding from the folding position, fold the braided cable shield onto the mold shell.

The shape of the folding region of the braided cable shield can be advantageously influenced as a result of the mold shell according to the invention.

As a result of the mold shell according to the invention being used, the flexibility in terms of folding the braided cable shield is enhanced because the braided cable shield no longer has to be mandatorily folded directly onto the cable, or the cable sheath thereof, respectively, or a plug connector component of the later plug connector. The profile of the folded braided cable shield thus in particular no longer mandatorily depends directly on the external geometry of a plug connector component of the later plug connector.

For example, when a support sleeve of the later plug connector that is preassembled on the cable sheath has an axial longitudinal slot, it can occur in practice that individual wires of the braided cable shield enter the longitudinal slot during folding, and as a result of the increased length associated therewith protrude beyond the rear end of the support sleeve in an undefined manner. This has to be avoided in order to guarantee positive electrical properties and to avoid short circuits in the context of the assembly of the plug connector.

As a result of the mold shell, the radial distance, or the spacing, respectively, of the folded braided cable shield from the cable sheath of the cable, or from a plug connector component of the plug connector preassembled on the cable sheath, can be predefined or influenced, respectively.

Moreover, by positioning the front end of the mold shell, the axial folding position along the longitudinal axis of the cable can moreover be predefined by the mold shell.

It is provided according to the invention that the folding position is determined in such a manner that the folding position differs from the first stripping position, and/or in that the mold shell has an end-face proximal detent face for the braided cable shield.

According to the invention it can henceforth be provided that the folding position is advantageously varied independently of the stripping position. As a result, tolerances in the first stripping position, or in one or a plurality of further stripping positions or assembly positions of the plug connector components, can be taken into account and compensated for, for example.

Moreover, it has been surprisingly demonstrated that the contacting of the braided cable shield by way of a plug connector component, for example a press-fit or crimped sleeve, can be improved when the folding position of the braided cable shield does not correspond directly to the first stripping position.

Contacting of the braided cable shield, for example by way of a press-fit or crimped sleeve or another plug connector component, can also be improved as a result of an end-face proximal detent face of the mold shell because the folded braided cable shield in this instance follows the profile of the detent face and can configure a “resilient” or elastic end-face proximal contact with the plug connector component.

The variants mentioned above are thus in particular associated with one another in that the contactability of the outer conductor with an outer conductor contact of the later plug connector can be improved in each case individually and in particular also in a synergetic combination with one another as a result of the shaping and positioning capability of the folding region of the braided cable shield.

In one advantageous refinement of the invention it can be provided that the folding position is determined in such a manner that the folding position along the longitudinal axis of the cable is disposed so as to be closer to the cable end to be processed than the first stripping position. In this way, the folding position along the longitudinal axis of the cable can be further to the “front” than the stripping position.

A spacing from the first stripping position can thus be maintained when folding the braided cable shield. This can be advantageous in particular for assembling a plug connector for the high-frequency sector, because the contact between an outer conductor contact of the plug connector and the braided cable shield of the cable in this instance can take place further toward the front on the cable.

In principle however, it can also be provided that the folding position corresponds to the first stripping position. A folding position which is set back so as to be behind the first stripping position can be provided in special cases, for example in order to fold the braided cable shield in stages.

According to one refinement of the invention it can be provided that the folding position is determined as a function of an assembly position of a plug connector component of an electrical plug connector preassembled on the cable.

As a result, tolerances in the assembly position of the plug connector component can be compensated for. It can in particular be avoided as a result that the folded braided cable shield protrudes rearward beyond the plug connector component, even when the assembly position of the plug connector component along the longitudinal axis of the cable is subject to high tolerances.

A plug connector component can in particular be a support sleeve, a press-fit sleeve or a crimping sleeve, respectively, or another outer conductor module, or another outer conductor component of the later plug connector.

According to one refinement of the invention it can be provided that the folding position is determined as a function of the first stripping position.

For example, it can be provided that the folding position is established at a defined spacing from the first stripping position, for example established so as to be offset by 0.1 mm to 5.0 mm from the first stripping position, preferably established so as to be offset by 0.1 mm to 2.0 mm from the first stripping position, most particularly preferably established so as to be offset by 0.1 mm to 1.0 mm from the first stripping position.

The first stripping position can in particular be a position along the longitudinal axis of the cable from where the cable sheath of the cable, and optionally also a cable film of the cable, is/are stripped. The stripping position can thus in particular be the axial position along the longitudinal axis of the cable from where the cable sheath and/or the cable film, proceeding from the front end of the cable, are present again.

In one refinement of the invention it can be provided that the folding position is determined as a function of a further stripping position proceeding from which a further cable component of the cable is exposed along the longitudinal axis of the cable up to the cable end to be processed.

For example, the further stripping position can be a stripping position from where a cable film is stripped in the direction toward that end of the cable that is to be processed, from where a filler layer (filler) which conjointly encases a plurality of inner conductors of the cable is stripped in the direction of that cable end of the cable that is to be processed, and/or from where an insulation which in each case encases the inner conductors of the cable is stripped in the direction of that cable end of the cable that is to be processed.

To the extent that the further stripping positions are taken into account for determining the folding position, corresponding tolerances of the further stripping positions can advantageously be taken into account when folding the braided cable shield.

A sensor installation can be used for determining the stripping position, in particular for detecting the first stripping position, the assembly position(s) and/or further stripping positions, or for measuring the cable and potentially preassembled plug connector components in order for the folding position to be determined, respectively. The sensor installation can preferably have at least one optical sensor, for example a camera, a light curtain and/or a light barrier.

In one refinement of the invention it can be provided that the mold shell is independent of an electrical plug connector to be assembled on the cable end to be processed.

The mold shell is thus preferably not a component part of the later plug connector. The mold shell is preferably only a component part of a device for processing the electrical cable, and can thus be advantageously used for folding the cable in the context of the invention.

In one advantageous refinement of the invention it can be provided that the mold shell is removed from the cable again once the braided cable shield has been folded onto the mold shell.

The mold shell can preferably be removed from the cable in a non-destructive manner.

For example, the mold shell can be extracted from the cable (to the “rear”) in the direction of the cable end which faces away from the cable end to be processed. However, the mold shell can also be removed laterally from the cable, by way of a linear and/or radial/curved movement. A motion sequence of the mold shell can also be provided for removing the mold shell, for example a rearward movement until the mold shell has been completely extracted from the braided cable shield, followed by a lateral extraction/removal/opening of the mold shell.

An actuator installation can be provided for the movement of the mold shell axially and/or radially relative to the cable (for actuating to the cable and/or removing from the cable).

The end-face proximal detent face of the mold shell preferably configures a defined edge for folding the braided cable shield.

In one refinement of the invention it can be provided that when the mold shell is applied to the cable the end-face proximal detent face of the mold shell at least in portions runs orthogonally to the longitudinal axis of the cable.

However, a non-orthogonal alignment of the end-face proximal detent face can also be provided, for example an arbitrary angular alignment of the detent face in relation to the longitudinal axis of the cable.

In one advantageous refinement of the invention it can be provided that the end-face proximal detent face of the mold shell is configured as a ring, in particular an annulus. The annular width of the annulus in relation to the internal radius of the annulus can preferably have a ratio of at least 1:20, preferably at least 1:10, particularly preferably at least 1:5. For example, smaller ratios or else larger ratios, for example of at least 1:2 or at least 1:1, can also be provided.

The annular width is preferably chosen in such a manner that a visible stage (composed of two kinked regions) is created in the folded braided cable shield.

An annulus has proven particularly suitable for configuring the end-face proximal detent face in particular.

In one advantageous refinement of the invention it can be provided that the mold shell at the front end, preferably between the end-face proximal detent face and a lateral face of the mold shell, has a chamfer and/or a transition radius.

A chamfer and/or a transition radius can further improve the brushing result when folding the braided cable shield, and moreover reduce the stress of the braided cable shield by sharp kinking.

In one advantageous refinement of the invention it can be provided that the mold shell has a round cross section.

In principle however, the mold shell may also have an oval, rectangular or any other cross section. The geometry here can preferably correspond, or at least approximately correspond, to the geometry of the cable sheath or to a plug connector component to be assembled on and/or below the folded braided cable shield.

Since the plug connector components to be assembled on or below the braided cable shield typically have a round inner or outer geometry, a round mold shell is typically advantageous.

In one refinement of the invention it can be provided that the mold shell tapers in the direction toward the front end. The mold shell can also taper only in portions.

In this way, the braided cable shield can also be not yet completely folded onto the cable sheath or the plug connector component if required, as a result of which further plug connector components of the later plug connector can be inserted, proceeding from the rear cable end, below the braided cable shield, for example.

According to one refinement of the invention it can be provided that the mold shell is configured from two half shells or more half shells which are actuated in the direction toward the longitudinal axis of the cable in order for the mold shell to be applied to the cable.

The mold shell can however also be integrally configured, in particular in the manner of a tube.

The mold shell preferably has exactly two half shells. However, the mold shell may also have three, four, five, six or more, half shells.

The use of a mold shell in multiple parts, in particular having two half shells, has proven to be particularly suitable in order for the mold shell to be applied to the cable and for said mold shell also to be easily removed from the cable once the braided cable shield has been folded.

In one advantageous refinement of the invention it can be provided that the mold shell is applied to the cable so as to be over a plug connector component of an electric plug connector preassembled on the cable, preferably so as to be over an axially slotted support sleeve of the plug connector.

In this way, the mold shell can cover the plug connector components of the later plug connector, for example the axially slotted press-fit sleeve of the plug connector, while the braided cable shield is being brushed. Unfavorable contours and regions of the plug connector components, for example an axial longitudinal slot, can thus no longer negatively influence the folding of the braided cable shield. Moreover, the plug connector components can be protected from the rotating brushes by the mold shell.

In one advantageous refinement of the connection it can be provided that, before and/or during the folding of the braided cable shield, a protective sleeve is inserted in the direction of the first stripping position along the longitudinal axis of the cable, so as to be between the braided cable shield and underlying cable components of the cable.

The protective sleeve is preferably configured in the manner of an integral tube. In principle, however, a protective sleeve in multiple parts can also be provided, for example a protective sleeve made from one, two or more, half shells.

A protective sleeve having only a minor wall thickness can be particularly suitable. The protective sleeve at the front end thereof can optionally have a chamfer in order to further facilitate insertion.

The internal radius of the protective sleeve preferably corresponds to the external radius of the cable components situated below the braided cable shield as accurately as possible so that no individual wires of the braided cable shield can unintentionally end up below the protective sleeve.

Only a relative movement between the cable and the protective sleeve is fundamentally crucial when inserting the protective sleeve. In this way, the protective sleeve can be moved toward the cable and/or the cable can be moved toward the protective sleeve.

The insertion of the protective sleeve below the portion of the braided cable shield to be brushed can be advantageous so as to protect regions below the braided cable shield, or cable components of the cable, respectively, in particular cable films, protective sheaths, dielectrics and/or inner conductors in relation to mechanical or thermal stress and/or in relation to electrostatic charging as a result of the brushing. The protective sleeve can be advantageous in particular for protecting a cable film, for example an aluminum foil or a composite film.

The use of a protective sleeve between the braided cable shield and the regions of the cable situated therebelow can optionally be dispensed with when the region of the cable directly below the braided cable shield is sufficiently insensitive in relation to the mechanical and thermal stress of the brushing. For example, when a sheath of polytetrafluoroethylene (e.g. Teflon) or PVC is used below the braided cable shield, the use of a sleeve can preferably be dispensed with.

The protective sleeve can advantageously also serve for centering or supporting that end of the electric cable that is to be processed, and for improved guiding of the cable.

According to one refinement of the invention it can be provided that the braided cable shield, prior to the insertion of the protective sleeve, is pre-processed so as to cause a radial enlargement.

In principle however, it is also possible for the protective sleeve to be inserted below the braided cable shield without first enlarging the braided cable shield.

In this way, the braided cable shield prior to the insertion of the protective sleeve can be at least partially radially set upright, in particular in the region of the front free end of the braided cable shield, so that the protective sleeve can advantageously make its way below the braided cable shield.

A radial enlargement can in particular be understood to be an elastic or plastic bending of the front free end of the braided cable shield in such a manner that the free end of the braided cable shield at least partially extends in the radial direction, but not mandatorily so as to be perpendicular, to the longitudinal axis of the electrical cable.

It can be particularly advantageous for the braided cable shield to be only slightly radially enlarged so as not to incorporate any defined abutting edge for the protective sleeve, because the protective sleeve otherwise could even further enlarge the braided cable shield instead of entering below the latter, as is desired here.

According to one variant for pre-processing the braided cable shield, a plier-like tool which is able to be radially actuated toward the exposed braided cable shield and is configured and specified to generate radially encircling impressions in the braided cable shield (preferably at the folding position or at least adjacent to the folding position) can be provided so that the exposed end of the braided cable shield is radially enlarged. The radial force for generating the impressions is advantageously less than a force which will be required for at least partially severing the braided cable shield. The plier-type tool can preferably be a shaped blade which is adapted to the external circumference of the electrical cable. A blunt shaped blade is preferably used.

Other solutions for enlarging the braided cable shield are also possible; the plier—type tool does not necessarily have to be used to this end. For example, pre-processing by means of the at least one brush can also be provided, wherein the brush in this instance partially uprights the braided cable shield preferably only in the region of the front free end by way of a brief and ideally gentle mechanical contact.

In one advantageous refinement of the invention it can be provided that the braided cable shield prior to folding by means of the at least one drivable brush is straightened by brushing in the direction of the cable end to be processed.

For this purpose, the brushes can first be rotated or driven, respectively, in the direction toward the front cable end. The brushing direction can be reversed again in order for the braided cable shield to be later folded.

The brushing movement of the brushes can reliably disentangle an interlaced braided cable shield and align the individual strands, or the individual wires, respectively, of the braided cable shield so as to be linear in the brushing direction.

In principle however, it can also be provided that the braided cable shield is not straightened by brushing prior to the braided cable shield been folded. Brushing may or not be provided, depending on the type of plug connector to be assembled on the cable end.

In one advantageous refinement of the invention it can be provided that at least two drivable brushes, at least three drivable brushes, or at least four drivable brushes, are used.

Comprehensive processing of the braided cable shield can take place as a result of the brushes being distributed along the circumference of the cable.

The use of exactly two brushes is particularly preferable because it has been demonstrated by means of experiments that a brushing result which is sufficient for folding the braided cable shield can be achievable already by using two brushes. In principle however, even more brushes may be provided. The use of only a single drivable brush may also be provided.

In one refinement of the invention it can be provided that, before and/or during brushing, the at least one drivable brush is actuated in the direction toward the longitudinal axis of the cable.

It can moreover be provided that the braided cable shield, during brushing, or during folding of the braided cable shield (or optionally also during the optional straightening of the braided cable shield by brushing), respectively, is moved along the at least one brush (for example between the brushes), and/or that the at least one brush is moved across the cable along the longitudinal axis of the cable.

The speed of the driven brushes, of the movement of the brushes along the longitudinal axis of the cable relative to the cable, as well as of the actuation of the braided cable shield during brushing, can be determined so as to be specific to the application.

An actuator module can be provided for the movement of the brushes axially and/or radially relative to the cable.

In one design embodiment of the invention it can be provided that the brushes are configured as round brushes. A round brush may be understood to be any brush which can be driven about a central axis, for example also so-called cup brushes and cone brushes. The round brushes do not have to be entirely round but may also be configured so as to be oval, for example. In principle, arbitrary brushes may be provided, for example also brushes which perform a linear movement, or revolving brushes.

It can be provided that the brushes have a nylon bristle set. In principle however, an arbitrary bristle set may be suitable, for example also a bristle set made from natural fibers, from man-made fibers, or from wire. The person skilled in the art can select a bristle set which is suitable for brushing the braided cable shield in an application-specific manner and as a function of the material of the braided cable shield.

In one advantageous refinement of the invention it can be provided that the at least one drivable brush during brushing is rotated about the cable along the circumference of the cable.

In particular when a minor number of brushes, for example only exactly one brush, is provided, it can be advantageous for the at least one brush during brushing to be rotated about the cable along the circumference of the cable. Folding or processing, respectively, of the braided cable shield can take place across the entire circumference as a result.

It can be provided that the cable during brushing, or during the folding of the braided cable shield, respectively, is fixed so as to be secured against rotation. A clamping device for securing the electrical cable against rotation during processing can be provided. Fixing the cable so as to be secured against rotation is typically advantageous for automated processing of the cable. Axially securing the electrical cable by means of the clamping device, permanently or only during specific processing steps, is also possible.

By virtue of the clamping device, the invention can in particular also be suitable for processing a cable end of an electrical cable which is disposed on a cable drum.

For example, the clamping device can have at least two clamping jaws which are actuatable toward the cable. In principle however, any arbitrary clamping device can be provided, in particular however a clamping device which is actuatable electrically, pneumatically and/or hydraulically and is capable of fixing the electrical cable in a force-fitting manner.

The clamping device can be configured so as to be movable in a linear manner by means of a rail system, for example, or optionally while using a cable pull and/or pneumatic and/or hydraulic components, in particular so as to move the exposed braided cable shield of the cable, counter to the brushing direction or in the latter, axially between the brushes during brushing.

The second, or the rear cable end, respectively, of the electrical cable can optionally also be processed according to the invention once the first or the front cable end, respectively, of the electrical cable has been processed.

After the brushing of the braided cable shield according to the invention, even further processing steps for fabricating the electrical cable can optionally also be provided up to a complete assembly of the plug connector in the context of the method according to the invention.

The invention also relates to a device for processing an electrical cable, said device having at least one drivable brush which is specified to fold a braided cable shield of the cable that, proceeding from a cable end to be processed, is exposed along a longitudinal axis of the cable up to a first stripping position, by brushing in the direction toward a cable end which faces away from the cable end to be processed. The device has a control installation which is specified to determine a defined folding position for the braided cable shield. The device furthermore has an actuator installation which is specified to apply a mold shell to the cable and to position the latter by way of a front end which faces the cable end to be processed at the folding position. It is provided that the folding position differs from the first stripping position and/or that the mold sleeve has an end-face proximal detent face for the braided cable shield.

In the inserted state, the electrical cable can also be considered to be part of the device in the context of the invention.

The method according to the invention and the device according to the invention can be particularly suitable for processing cables for use as data cables in the high frequency sector. For example, the use of the invention in the context of cables for vehicles, in particular motor vehicles, can also be advantageous. In principle, the invention is suitable for processing arbitrary cables for arbitrary fields of application within the entire field of electrical engineering.

The invention also relates to a computer program product having program code means for carrying out a method according to the embodiments above and hereunder when the program is executed on a control installation of a device for processing an electrical cable (in particular on a device according to the embodiments above and hereunder).

The invention moreover relates to a mold shell for a device for processing an electrical cable. The mold shell preferably has the features and advantages mentioned in the context of the method according to the invention and the device according to the invention.

The invention furthermore relates to an electrical cable which has been processed by a method according to the embodiments above and hereunder, or using a device according to the embodiments above and hereunder.

Features which have been described in the context of the method according to the invention can of course also be advantageously implemented for the device, the computer program product, the mold shell and the electrical cable, and vice versa. Furthermore, advantages which have already been mentioned in the context of the method according to the invention can also be understood to relate to the device, the computer program product, the mold sleeve and the electrical cable, and vice versa.

It is to be additionally pointed out that terms such as “comprising”, “having” or “with” do not preclude any other features or steps. Furthermore, terms such as “a/one” or “the”, which suggest a singularity of steps or features, do not preclude a plurality of steps or features, and vice versa.

In a puristic embodiment of the invention, it may however also be provided that the features introduced in the invention by the terms “comprising”, “having” or “with” constitute an exhaustive list. Accordingly, in the context of the invention, one or more enumerations of features can be considered in self-contained form, for example considered respectively for each claim. For example, the invention can be composed exclusively of the features mentioned in claim 1.

It is furthermore emphasized that the values and parameters described in the present case also encompass deviations or fluctuations of ±10% or less, preferably ±5% or less, more preferably ±1% or less, and very particularly preferably ±0.1% or less, of the respectively stated value or parameter, if such deviations are not ruled out in practice in the implementation of the invention. The specification of ranges by way of start and end values also encompasses all values and fractions encompassed by the respectively stated range, in particular the start and end values and a respective mean value.

Exemplary embodiments of the invention will be described in more detail hereunder by means of the drawing.

The figures show in each case preferred exemplary embodiments in which individual features of the present invention are illustrated in combination with one another. Features of one exemplary embodiment can also be implemented independently of the other features of the same exemplary embodiment and can accordingly be readily combined with features of other exemplary embodiments by a person skilled in the art so as to form further expedient combinations and sub-combinations.

In the figures, functionally identical elements are provided with the same reference signs.

In the figures, in each case schematically:

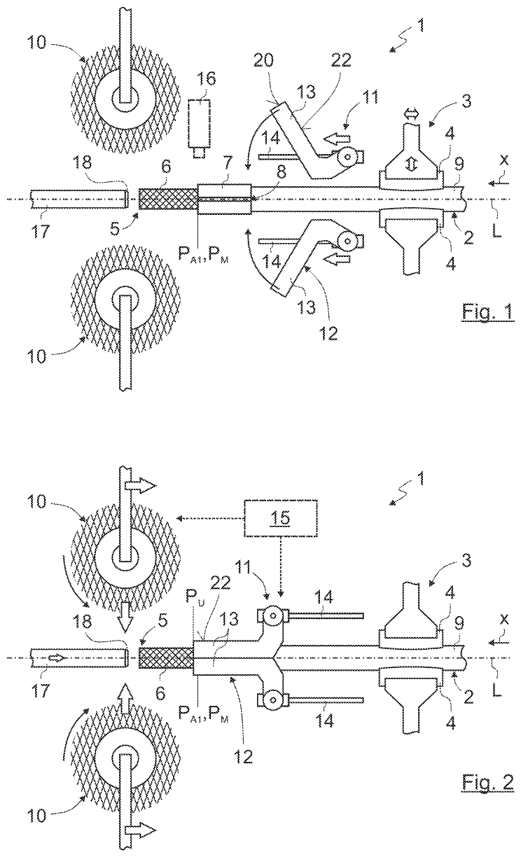

FIG. 1 shows the device according to the invention in a state prior to applying the mold shell to the cable;

FIG. 2 shows the device according to the invention in a state after the application of the mold shell to the cable and during the actuation of the brushes;

FIG. 3 shows the device according to the invention in a state during the brushing of the braided cable shield for folding the braided cable shield;

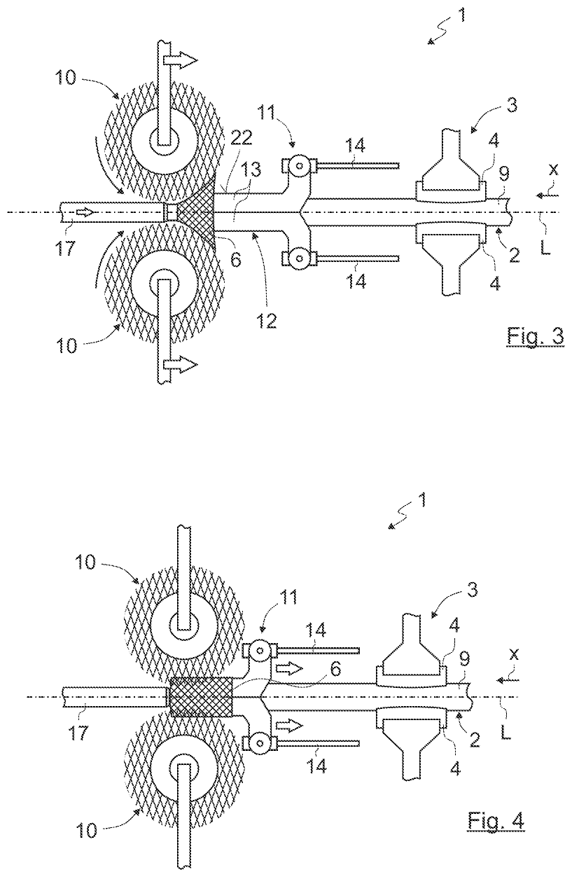

FIG. 4 shows the device according to the invention in a state after the folding of the braided cable shield and prior to the removal of the mold shell;

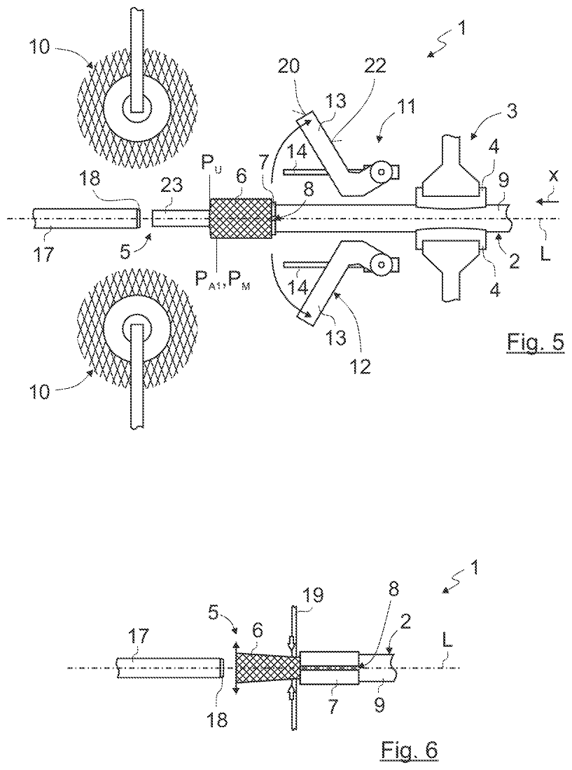

FIG. 5 shows the device according to the invention in a state after the removal of the mold shell;

FIG. 6 shows an exemplary pre-processing of the braided cable shield using a plier-like tool for radially enlarging the braided cable shield;

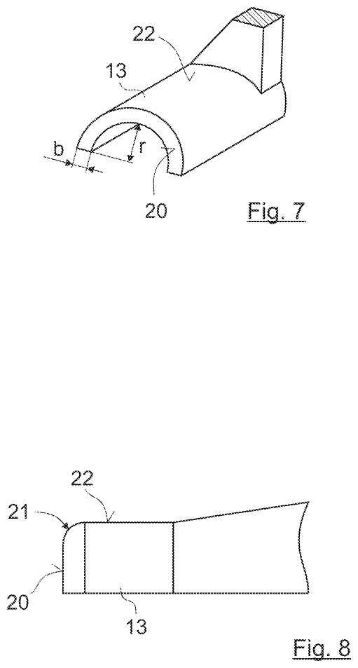

FIG. 7 shows a perspective view of a half shell of a multi-part mold shell;

FIG. 8 shows a lateral view of a half shell of a further multi-part mold shell having a transition radius;

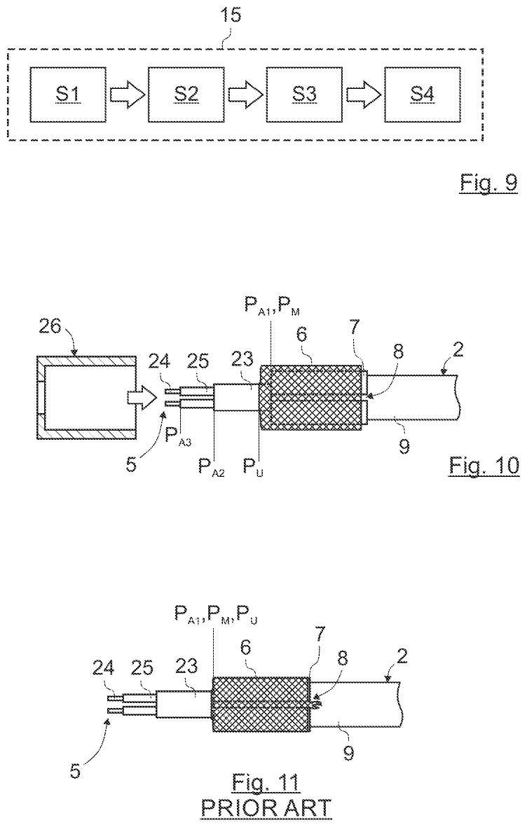

FIG. 9 shows an exemplary method sequence for the processing of the cable end;

FIG. 10 shows a cable processed in an exemplary manner after the folding of the braided cable shield according to the invention while attaching a press-fit sleeve; and

FIG. 11 shows a cable processed in an exemplary manner after the folding of the braided cable shield according to the prior art.

FIGS. 1 to 5 show a device 1 according to the invention for processing an electrical cable 2 in different states during processing according to the invention.

FIG. 1 first shows a basic state of the device 1, for example after the insertion of the cable 2 by a production operator and an actuation of the cable 2 into an initial position. The device 1 for actuating the cable 2 can have a clamping device 3 having two clamping jaws 4 which are able to be actuated toward the cable 2, for example. The clamping jaws 4 can fix the cable 2 therebetween. Furthermore, the clamping device 3, or the clamping jaws 4, respectively, can be movable along an advancing direction x (cf. arrow in FIG. 1) so as to transport the cable 2 before, during or after the processing thereof. The clamping device 3, or the clamping jaws 4, respectively, can be specified to hold the cable 2 so as to be secured against rotation.

In principle, the invention is suitable for processing a cable end 5 to be processed of an arbitrary electric cable 2, the latter having an outer conductor, in particular a braided cable shield 6. The processing according to the invention can in particular be performed on an electrical cable 2 of which the braided cable shield 6, proceeding from the cable end 5 to be processed, is exposed along the longitudinal axis L of the cable 2 up to a first stripping position P_{A1}.

Optionally, a plug connector component of the later plug connector (the later plug connector is not illustrated in the figures) can already be preassembled on the cable 2, or be fastened to the latter, respectively. In an exemplary manner, a support sleeve 7 having an axial longitudinal slot 8 is illustrated in the figures. The invention is particularly advantageously suitable for processing an electrical cable 2 having a pre-fitted support sleeve 7 having a longitudinal slot 8.

In the present case, the support sleeve 7 by way of the front end thereof is positioned in an exemplary manner so as to be exactly at the stripping position P_{A1}, proceeding from which the braided cable shield 6 is released from a cable sheath 9 of the cable 2. The assembly position P_{M} of the support sleeve 7 thus corresponds to the stripping position P_{A1}. This is however not mandatory; in particular, the support sleeve 7 can also be positioned further toward the rear of further toward the front.

In the context of the processing according to the invention it is provided that the braided cable shield 6, while using at least one drivable brush 10, is folded back in the direction to a cable end (not illustrated) which faces away from the cable end 5 to be processed. In an exemplary manner, the illustrated device 1 has exactly two drivable brushes 10. In principle however, a single brush 10 may also be provided. More than two brushes 10 may also be provided, for example three brushes 10, four brushes 10, or even more brushes 10. However, the use of exactly two brushes 10 is particularly advantageous with a view to the processing according to the invention.

The device 1 has an actuator installation 11 which is specified to apply a mold shell 12 to the cable 2. The actuator installation 11 illustrated in an exemplary manner is configured to apply a mold shell 12, configured from two half shells 13, laterally to the cable 2 by way of a rotating movement. In principle however, the half shells 13 may also be actuated in the direction toward the longitudinal axis L of the cable 2 by an exclusively linear movement. The exact type of actuation is not necessarily important in the present case. The mold shell 12 can also be composed of more than two half shells 13, have further components, or even be integrally configured (e.g. in the manner of a tube), for example. The person skilled in the art may correspondingly adapt the actuation, or the actuator installation 11, respectively.

The actuator installation 11 is furthermore configured to position the mold shell 12 by way of a front end which faces the cable end 5 to be processed at a defined folding position Pᵤ. A linear guide along two rails 14 is provided in an exemplary manner to this end.

FIG. 2 shows the state of the device 1 after the application of the mold shell 12 to the cable 2, and during the actuation of the brushes 10.

Moreover, in FIG. 2, a control installation 15 is illustrated in dashed lines in an exemplary manner as a black box, said control installation 15 being capable of carrying out and monitoring a method according to the invention. To this end, the control installation 15 can be specified, for example, to transmit control signals to the actuator installation 11 and/or further actuators, for example an actuator module for actuating the brushes 10 (likewise indicated in FIG. 2). The control installation 15 can moreover be specified to determine the defined folding position P_{U} for the braided cable shield 6, so as to subsequently position the front end of the mold sleeve 12 by the actuator installation 11 in a corresponding manner.

As is illustrated in FIG. 2, the folding position P_{U} according to the invention can differ from the first stripping position P_{A1}. The folding position P_{U} in the present case has been determined in such a manner that the folding position P_{U} along the longitudinal axis L of the cable 2 is disposed so as to be closer to the cable end 5 to be processed than the first stripping position P_{A1}. The folding position P_{U} can in particular also be determined as a function of the assembly position P_{M} of a preassembled plug connector component of the later electrical plug connector, thus as a function of the position of the support sleeve 7, for example. Moreover, the folding position P_{U} can be determined as a function of the first stripping position P_{A1}. Furthermore, the folding position P_{U} can be determined as a function of one or a plurality of further stripping positions P_{A2}, P_{A3} (cf. FIG. 10).

A sensor installation 16 (indicated in an exemplary manner only in FIG. 1) which for communications can be connected to the control installation 15 can be used for determining the folding position Pᵤ, for example. The sensor installation 16 can be configured as a camera, for example, and can measure the cable 2 and/or a plug connector component preassembled on the cable 2, or the position of the latter.

Once the mold shell 12 has been applied to the cable 2, or while the mold shell 12 is being applied to the cable 2, the at least one drivable brush 10 can be actuated in the direction toward the longitudinal axis L of the cable 2, as is indicated in FIG. 2. Furthermore, the brushes 10 can be driven in the direction toward the rear cable end which faces away from the cable end 5 to be processed, and said brushes 10 can simultaneously be moved, counter to the advancing direction x of the cable 2 toward the first stripping position P_{A1}, in particular as soon as the brushes 10 come into contact with the braided cable shield 6. Important here is only a relative movement between the cable 2 and the brushes 10; a movement of the brushes 10 is illustrated in an exemplary manner in the exemplary embodiment, but in principle the cable 2 can additionally or alternatively also be moved in the direction toward the brushes 10.

FIG. 3 shows a state of the device 10 during the brushing of the braided cable shield 6 for folding the braided cable shield 6. In order for the cable components of the cable 2 situated below the braided cable shield 6 of the cable 2 to be protected, the protective sleeve 17 illustrated can be inserted along the longitudinal axis L of the cable 2 in the direction toward the first stripping position P_{A1}, between the braided cable shield 6 and the underlying cable components of the cable 2 (for example a cable film). In able for the insertion of the support sleeve 7 to be simplified, the braided cable shield 6 can previously be pre-processed so as to cause a radial enlargement, in particular at the front, free end of the braided cable shield 6. This is described in more detail hereunder. In order for the insertion to a simplified, the support sleeve 7 at the front, free end thereof can moreover have a chamfer 18.

Optionally, it can be provided that the at least one drivable brush 10 during the brushing 10 is rotated about the cable 2 along the circumference of the cable 2. This is not illustrated in the exemplary embodiments and is typically also advantageous only when exactly one brush 10 is used.

Optionally, it can be moreover provided that the braided cable shield 7, before being folded by means of the at least one drivable brush 10, is straightened by brushing in the direction toward the cable end 5 to be processed. This is likewise not illustrated in the exemplary embodiments. The braided cable shield 6 is preferably not brushed before being folded by the brushes 10.

FIG. 4 shows the device 1 in a state after the complete folding of the braided cable shield 6 onto the mold shell 12.

Once the braided cable shield 6 has been folded onto the mold shell 12, the mold shell 12 can be removed from the cable 2 again, as is illustrated in FIG. 5, for example. To this end, the mold shell 12 can be moved by the actuator installation 11, for example counter to the advancing direction x, or in the direction toward the rear cable end which faces away from the cable end 5 to be processed, respectively, and subsequently be removed laterally from the cable 2, for example again by the rotating movement illustrated. Finally, the cable 2 can optionally be moved out of the device 1 by the clamping device 3 and/or be released for removal.

In an exemplary manner, pre-processing of the braided cable shield 6 for radially enlarging the braided cable shield 6 so as to be able to insert the protective sleeve 17 more easily below the braided cable shield 6 is illustrated in FIG. 6. Illustrated to this end in an exemplary manner is a plier-like tool 19 which in the direction of the longitudinal axis L of the cable 2 is able to be actuated radially toward the braided cable shield 6. Radial impressions in the braided cable shield 6 can be generated by means of the plier-like tool 19, so that the exposed end of the braided cable shield 6 is radially enlarged. Alternatively or additionally, enlarging the braided cable shield 6 by means of the at least one brush 10 can also be provided.

A single half shell 13 of the multi-part mold shell 12 is shown in a perspective view in FIG. 7. Of course, the illustration is to be understood to be merely exemplary. The mold shell 12 has an end-face proximal detent face 20 for the braided cable shield 6. The end-face proximal detent face 20 of the mold shell 12 here preferably runs orthogonally to the longitudinal axis L of the cable 2 when the mold shell 12 is applied to the cable 2.

As a result of the end-face proximal detent face 20 of the mold shell 12, the braided cable shield 6 can be folded in a defined manner. The end-face proximal detent face 20 here is particularly preferably configured as an annulus, as illustrated. The annular width b of the annulus in relation to the internal radius r thereof can have a ratio of at least 1:20, preferably at least 1:10, particularly preferably at least 1:5. Larger or smaller ratios are also possible, however.

Moreover, the mold shell 12 preferably has a round cross section. However, any other cross sections, for example an oval cross-section or a rectangular cross section, may also be suitable.

A half shell 13 of a further exemplary mold shell 12 is shown in a lateral view in FIG. 8. The mold shell 12, or the half shell 13, respectively, at the front end has a transition radius 21 which, proceeding from the end-face proximal detent face 20, extends to the lateral face 22 of the mold shell 12. As a result, the transition of the braided cable shield 6, proceeding from the detent face 20 to the lateral face 22, can be predefined in a gentler manner.

The mold shell 12 can also taper in the direction toward the front end, for example. The mold shell 12 can also taper in the direction toward the front end only in regions. An exemplary taper in portions is illustrated in FIG. 8. As a result, the braided cable shield 6 can follow a predefined profile of the mold shell 12.

Illustrated in FIG. 9 is an exemplary method sequence for the processing of the cable end 5. The method steps shown can optionally also be interchanged or further sub-divided. Moreover, further method steps can also be provided in the context of the method according to the invention. Therefore, the method sequence illustrated is to be understood to be merely exemplary. The method can be carried out as a computer program product having program code means on the control installation 15 of the device 1. The control installation 15 is illustrated in an exemplary manner by dashed lines.

According to a first method step S1, the defined folding position P_{U} for the braided cable shield 6 can first be determined along the longitudinal axis L of the cable 2. Subsequently, in a second method step S2, the mold shell 12 can be applied to the cable 2 and by way of the front end of said mold shell 12 which faces the cable end 5 to be processed be positioned at the folding position P_{U}. Subsequently, in a third method step S3, the braided cable shield 6 by means of the at least one brush 10 can be brushed back in the direction toward the cable end which faces away from the cable end 5 to be processed. Finally, in a fourth method step S4, the mold shell 12 can be removed from the cable 2 again.

FIG. 10 shows an exemplary cable 2 after the folding of the braided cable shield 6 according to the invention. The profile of the support sleeve 7 below the braided cable shield 6 is indicated by dashed lines.

The cable 2 illustrated in an exemplary manner is configured as a two-core data cable. A filler layer 23 runs below the braided cable shield 6, the inner conductors 24 of the cable 2 running in said filler layer 23. Optionally, a cable film which for reasons of simplicity is not illustrated in the exemplary embodiment, can optionally also run between the filler layer 23 and the braided cable shield 6. The inner conductors 24 of the cable 2 are in each case encased by an insulation 25. The construction of the cable 2 is understood to be merely exemplary and can be arbitrary in principle. For example, a coaxial cable can also be processed according to the invention.

It can be seen that the folding position P_{U} by virtue of the processing according to the invention differs from the first stripping position P_{A1}.

For comparison, a cable 2 processed according to the prior art is shown in an exemplary manner in FIG. 11, the folding position P_{U} and the first stripping position P_{A1} being identical in said cable 2.

For example, when, proceeding from the cable end 5 to be processed, a press-fit sleeve 26, or a crimped sleeve (cf. FIG. 10) is applied to the cable 2 in order to compress the braided cable shield 6 between the press-fit sleeve 26 and the support sleeve 7 in a subsequent crimping process, the contact between the press-fit sleeve 26 and the braided cable shield 6 can be improved as a result of the inventive positioning of the folding position P_{U} ahead of the first stripping position P_{A1} because the braided cable shield 6 as a result of the upstream position, spaced apart from the support sleeve 7, is better able to contact the end-face proximal internal face of the press-fit sleeve 26.

Moreover, it can be avoided by virtue of the mold shell 12 according to the invention that the braided cable shield 6 as a result of the brushing follows the specific geometric parameters or structures, respectively, of the support sleeve 7 and enters the longitudinal slot 8 by way of one or a plurality of individual wires, for example. As a result, it can be prevented that individual wires of the braided cable shield 6 protrude beyond the press-fit sleeve 26 in the direction toward the cable end which faces away from the cable end 5 to be processed, as is indicated in FIG. 11.

What is claimed is:

1. A method for processing an electrical cable, according to which method a braided cable shield of the cable that, proceeding from a cable end to be processed, is exposed along a longitudinal axis of the cable up to a first stripping position, by brushing by means of at least one drivable brush is folded back in the direction of a cable end which faces away from the cable end to be processed,
wherein a defined folding position for the braided cable shield is determined along the longitudinal axis of the cable, wherein a mold shell is applied to the cable before and/or during brushing and by way of a front end which faces the cable end to be processed is positioned at the folding position so as to, proceeding from the folding position, fold the braided cable shield onto the mold shell,
wherein the folding position is determined in such a manner that the folding position differs from the first stripping position; and
wherein the mold shell is removed from the cable again once the braided cable shield has been folded onto the mold shell.

2. The method as claimed in claim 1, wherein the folding position is determined in such a manner that the folding position along the longitudinal axis of the cable is disposed so as to be closer to the cable end to be processed than the first stripping position.

3. The method as claimed in claim 1, wherein the folding position is determined as a function of an assembly position of a plug connector component of an electrical plug connector preassembled on the cable.

4. The method as claimed in claim 1, wherein the folding position is determined as a function of the first stripping position.

5. The method as claimed in claim 1, wherein the folding position is determined as a function of a further stripping position proceeding from which a further cable component of the cable is exposed along the longitudinal axis of the cable up to the cable end to be processed.

6. The method as claimed in claim 1, wherein the mold shell is independent of an electrical plug connector to be assembled on the cable end to be processed.

7. (canceled)

8. The method as claimed in claim 1, wherein when the mold shell is applied to the cable the end-face proximal detent face of the mold shell at least in portions runs orthogonally to the longitudinal axis of the cable.

9. The method as claimed in claim 1, wherein the end-face proximal detent face of the mold shell is configured as an annulus, the annular width thereof in relation to the internal radius thereof having a ratio of at least 1:20.

10. The method as claimed in claim 1, wherein the mold shell at the front end, preferably between the end-face proximal detent face and a lateral face of the mold shell, has a chamfer and/or a transition radius.

11. The method as claimed in claim 1, wherein the mold shell (12) has a round cross section.

12. The method as claimed in claim 1, wherein the mold shell (12) tapers in the direction toward the front end.

13. The method as claimed in claim 1, wherein the mold shell is configured from two half shells or more half shells which, for applying the mold shell to the cable, are actuated in the direction of the longitudinal axis of the cable.

14. The method as claimed in claim 1, wherein the mold shell is applied to the cable so as to be over a plug connector component of an electrical plug connector preassembled on the cable, preferably so as to be over an axially slotted support sleeve of the plug connector.

15. The method as claimed in claim 1, wherein before and/or during the folding of the braided cable shield, a protective sleeve is inserted in the direction of the first stripping position along the longitudinal axis of the cable, so as to be between the braided cable shield and underlying cable components of the cable.

16. The method as claimed in claim 15, wherein the braided cable shield, prior to the insertion of the protective sleeve, is pre-processed so as to cause a radial enlargement.

17. The method as claimed in claim 1, wherein the braided cable shield prior to folding by means of the at least one drivable brush is straightened by brushing in the direction of the cable end to be processed.

18. (canceled)

19. The method as claimed in claim 1, wherein before and/or during brushing, the at least one drivable brush is actuated in the direction toward the longitudinal axis of the cable.

20. The method as claimed in claim 1, wherein the at least one drivable brush during brushing is rotated about the cable along the circumference of the cable.

21. A device for processing an electrical cable, said device having at least one drivable brush which is specified to fold a braided cable shield of the cable that, proceeding from a cable end to be processed, is exposed along a longitudinal axis of the cable up to a first stripping position, by brushing in the direction toward a cable end which faces away from the cable end to be processed,
wherein a control installation is provided and specified to determine a defined folding position for the braided cable shield, and wherein an actuator installation is provided and specified to apply a mold shell to the cable and to position the latter by way of a front end which faces the cable end to be processed at the folding position,
wherein the folding position differs from the first stripping position; and
wherein the mold shell is removed from the cable again once the braided cable shield has been folded onto the mold shell.

22. (canceled)

23. (canceled)

24. (canceled)

25. A method for processing an electrical cable, according to which method a braided cable shield of the cable that, proceeding from a cable end to be processed, is exposed along a longitudinal axis of the cable up to a first stripping position, by brushing by means of at least one drivable brush is folded back in the direction of a cable end which faces away from the cable end to be processed,
wherein a defined folding position for the braided cable shield is determined along the longitudinal axis of the cable, wherein a mold shell is applied to the cable before and/or during brushing and by way of a front end which faces the cable end to be processed is positioned at the folding position so as to, proceeding from the folding position, fold the braided cable shield onto the mold shell,
wherein the mold shell has an end-face proximal detent face or the braided cable shield, and
wherein the mold shell is removed from the cable again once the braided cable shield has been folded onto the mold shell.
